(19) United States
(12) Patent Application Publication
(10) Pub. No.: US 2025/0091879 A1
(43) Pub. Date: Mar. 20, 2025

(54) METHOD FOR PREPARING NON-OXIDIZED CARBON NANOTUBE DISPERSION THROUGH MECHANICAL IMPREGNATION, AND NON-OXIDIZED CARBON NANOTUBE DISPERSION PREPARED THEREBY

(71) Applicant: KOREA ELECTROTECHNOLOGY RESEARCH INSTITUTE, Changwon-si (KR)

(72) Inventors: Seung Yol JEONG, Changwon-si (KR); Byeong Guk KIM, Changwon-si (KR); Ick Jun KIM, Changwon-si (KR); Sun Hye YANG, Changwon-si (KR); Geon Woong LEE, Changwon-si (KR); Hye Jung LEE, Changwon-si (KR); Soo Yeon JEONG, Changwon-si (KR); Jung Mo KIM, Changwon-si (KR); Ji Hyeon RYU, Changwon-si (KR); Hee Jin JEONG, Changwon-si (KR)

(21) Appl. No.: 18/937,567

(22) Filed: Nov. 5, 2024

Related U.S. Application Data
(63) Continuation of application No. PCT/KR2022/012945, filed on Aug. 30, 2022.

(30) Foreign Application Priority Data
Aug. 16, 2022 (KR) 10-2022-0102328

(51) Int. Cl. C01B 32/174

(52) U.S. Cl. CPC C01B 32/174; C01B 2202/02; C01B 2202/06; C01B 2202/10; C01B 2202/34; C01P 2004/03; C01P 2006/40

(57) ABSTRACT

The present invention relates to: a method for preparing a non-oxidized carbon nanotube dispersion through mechanical impregnation so as to apply carbon nanotubes having a hydrophobic surface and a bundle shape as a high-performance conductive material of a negative electrode or a positive electrode for a secondary battery through solvent dispersion without acid treatment; and a non-oxidized carbon nanotube dispersion for a conductive material of a secondary battery, prepared by the method.

### REFERENCE TO RELATED APPLICATIONS

This is a continuation of International Patent Application PCT/KR2022/012945 filed on Aug. 30, 2022, which designates the United States and claims priority of Korean Patent Application No. 10-2022-0102328 filed on Aug. 16, 2022, the entire contents of which are incorporated herein by reference.

### FIELD OF THE INVENTION

The present disclosure relates to a method of preparing a non-oxidized carbon nanotube dispersion solution using mechanical impregnation, and a non-oxidized carbon nanotube dispersion solution for secondary battery conductive materials prepared thereby.

### BACKGROUND OF THE INVENTION

Increased energy density and shortened charging time are required to develop high-performance secondary batteries. To fulfill these needs, it is essential to use high-nickel-based materials for a positive electrode material and silicon for a negative electrode material. With the advancements, technological development has focused on overcoming technological limitations to apply new materials, including next-generation materials such as carbon nanotubes (CNTs), graphene, and carbon nanofibers. These new materials are used to enhance electrical conductivity and expansion, efficiency, and lifespan of silicon.

Depending on the application field of the secondary battery, electrode materials are distinguished. Applying high-performance conductive materials is essential to overcome cell performance degradation caused by surface properties of electrode materials and size diversity.

Conventional carbon black has a bulky structure and is limited in its ability to improve conductivity (up to 1 S/cm). In addition, conventional carbon black has a particle form. Due to these, large amounts of binder are needed to ensure the mechanical stability of the electrode. Meanwhile, by forming composites with carbon nanomaterials such as CNTs or graphene, it is possible to achieve improved electrical conductivity with a small amount of the composites. Since the composites have superior mechanical properties to carbon black, which exists in an aggregated form, structural stability may be secured. This is because a continuous network becomes easy to form within the electrode.

For example, CNT conductive materials show significantly superior performance to conventional carbon black when the CNT conductive materials are used as an additive in lithium-ion batteries. This means that the amount of conventional conductive materials used may be reduced to ⅕, which increases the proportion of active materials and enables the realization of high-capacity electrode technique.

Major domestic battery manufacturers have started to apply a linear conductive material of CNTs instead of a particle-type conductive material based on carbon black to an electrode process for some secondary batteries, although the application is limited to small IT products only. The manufacturers are conducting research with carbon nano manufacturers to develop carbon nano shape control techniques such as CNTs to achieve cell performance improvement.

In particular, silicon-based active materials are emerging to be applied for high-capacity negative electrode materials. Since most negative electrode manufacturing processes are aqueous processes, there is a demand for an aqueous dispersion technique of hydrophobic carbon nanomaterials (CNTs and graphene). Currently, CNTs are sold in small quantities included in organic dispersion solutions, and the electrical conductivity of the CNTs is approximately up to 100 S/cm.

Carbon nanotubes are divided into single-walled carbon nanotubes (1 to 3 nm), double-walled carbon nanotubes (3 to 4 nm), thin multi-walled carbon nanotubes (4 to 20 nm), and multi-walled carbon nanotubes (20 to 50 nm) depending on the number of synthesized layers. The four types may be classified by diameter. In particular, single-walled carbon nanotubes have significantly small diameters and significantly large aspect ratios. Due to that, van der Waals forces between the tubes during synthesis occur, resulting in the preparation of single-walled carbon nanotubes in a bundle shape. At this point, the diameter of the bundle is about several millimeters (mm) when the bundle takes a flake form. To realize the excellent performance of carbon nanotubes, single-walled carbon nanotubes need to be prepared to make intermediate materials through debundling and dispersion in a suitable solvent. This is a significantly important factor in applications. Conventional methods proposed for debundling and dispersing carbon nanotubes are largely divided into two types.

The first is a chemical method that uses strong acids to introduce oxygen functional groups into carbon nanotubes and then debundle and disperse the carbon nanotubes. The method of debundling and dispersing carbon nanotubes using strong acid or oxidizing agent as a method of preparing oxidized carbon nanotubes is effective in securing dispersibility. In addition, the method helps minimize the size of the bundle, thereby improving the properties of carbon nanotubes and facilitating the dispersion of the carbon nanotubes. However, the method has limitations in that the acid treatment induces defect formation, leading to deterioration of electrical properties, an additional reduction process is required to remove oxygen functional groups, and acid wastewater treatment is needed due to the use of strong acids.

The second is a method of using carbon nanotubes with a dispersant or a binder. This method is a method of preparing non-oxidized carbon nanotubes, the method being of debundling and dispersing carbon nanotubes using a dispersant or binder. Since no acid is treated, the defect formation may be minimized. However, the dispersant or binder is required to penetrate between CNT bundles for debundling and dispersion. For this, usually, the length of CNTs is required to be minimized through various mechanical pulverizing processes. At this time, the length of CNTs becomes very short, being less than sub-micron (<1 μm). In this situation, the electrical properties of CNTs are diminished due to defect formation caused by the exposure of edge sites in carbon nanotubes. In addition, there is another limitation in that a large amount of dispersant is needed for use, which causes high interfacial resistance.

Herein, a process of pre-dispersing carbon nanotubes with a dispersant is generally required as a method of using carbon nanotubes in the negative electrode slurry process of a secondary battery. For this, carbon nanotubes are mixed with a dispersant and then cut using strong shear forces. The dispersant penetrates between the CNT bundles, effectively dispersing the carbon nanotubes. However, in the case of carbon nanotubes in a very long bundle shape, the spacing between bundles (<3 nm) is very narrow, so penetration of the dispersant is very difficult. This illustrates that the penetration ability of the dispersant is a significantly important factor. Accordingly, to maximize the penetration of the dispersant between the CNT bundles, a method of reducing the length of the bundles by pulverizing the carbon nanotubes is used. For effective debundling and dispersion, the reality is that intermediate materials have been prepared through a process for increasing the pulverization of carbon nanotubes and the content of a dispersant. Although the method improves dispersibility, it results in decreased electrical conductivity and only allows the preparation of dispersion solutions at a low concentration. Therefore, the intermediate materials prepared that way have limitations in being used as a pre-dispersed solution, which means limitations in being used as an intermediate material for incorporating conductive materials into secondary batteries.

Accordingly, a technical method is required to minimize the pulverization of carbon nanotubes and reduce the content of a dispersant, thereby maximizing debundling and dispersibility. Thus, in view of the technical requirements, the inventors of the present disclosure developed a pre-dispersion process that enables carbon nanotubes having a hydrophobic surface and a bundle shape to be used as high-performance conductive materials through solvent dispersion without acid treatment and completed the present disclosure.

### SUMMARY OF THE INVENTION

To address the limitations, the present disclosure provides a method of preparing a non-oxidized carbon nanotube dispersion solution using mechanical impregnation for carbon nanotubes having a hydrophobic surface and a bundle shape to be dispersed in a solvent without acid treatment. In addition, the present disclosure provides a non-oxidized carbon nanotube dispersion solution for secondary battery conductive materials prepared by the method.

To address the limitations, the present disclosure may provide a method of preparing a non-oxidized carbon nanotube dispersion solution using mechanical impregnation, the method including: preparing a carbon nanotube dough by kneading carbon nanotubes in a bundle shape and alcohol so that the surface of each of the carbon nanotubes in the bundle shape is wet; preparing a carbon nanotube-binder mixture by mixing the carbon nanotube dough with a binder and applying a shear force to the mixture; and preparing a carbon nanotube dispersion solution in which each of the carbon nanotubes is debundled and dispersed by sonicating the carbon nanotube-binder mixture. Herein, after alcohol penetrates between each of the carbon nanotubes during kneading, the binder may penetrate between each of the carbon nanotubes during the preparation of the carbon nanotube-binder mixture, thereby mechanical impregnation may take place.

In the present disclosure, the preparation of the carbon nanotube dough may involve kneading the carbon nanotubes and alcohol at a weight ratio of 1:5 to 20.

In the present disclosure, the carbon nanotube may include one or more selected from the group consisting of a single-walled carbon nanotube (SWCNT), a double-walled carbon nanotube (DWCNT), a thin multi-walled carbon nanotube (thin MWCNT), and a multi-walled carbon nanotube (MWCNT).

In the present disclosure, the binder may include one or more selected from the group consisting of carboxymethyl cellulose (CMC), polyacrylic acid (PAA), polyvinylidenefluoride (PVDF), polyvinyl alcohol (PVA), polymethyl methacrylate (PMMA), polyvinyl alcohol-polyacrylic acid copolymers (PVA-PAA copolymers), lithium polyacrylate (LiPAA), polyimide (PI), polyisobutylene (PIB), and styrene-butadiene rubber (SBR).

In the present disclosure, the debundled carbon nanotubes may have a length in a range of 1 to 50 μm.

To address the other technical limitations mentioned above, the present disclosure may provide a non-oxidized carbon nanotube dispersion solution prepared by the method.

According to the present disclosure to address the limitations, a non-oxidized carbon nanotube dispersion solution in which hydrophobic carbon nanotubes are uniformly dispersed can be prepared without acid treatment to improve the performance of conductive materials for secondary batteries. That is, by adding a small amount of alcohol solvent to the surface of carbon nanotube particles with a hydrophobic surface and using a kneading method to wet the surface, an environment is created for a binder to be inserted more smoothly between carbon nanotube bundles. Following this, a shear force is applied to effectively insert the binder between the carbon nanotube bundles, while ultrasound is used to induce debundling and dispersion. Through this, carbon nanotubes can be dispersed more uniformly in a solvent. Thus, the method is effective in preparing a non-oxidized carbon nanotube dispersion solution.

In particular, carbon nanotubes are debundled and dispersed in a non-oxidizing manner through mechanical impregnation without using a separate dispersant (for example, surfactant) and without acid treatment. Therefore, the debundled carbon nanotubes may have a length of up to 50 μm. This ultimately has the effect of minimizing defects and improving electrical conductivity of carbon nanotubes, allowing the carbon nanotubes to be used as conductive materials for the negative or positive electrode of secondary batteries.

Accordingly, a non-oxidized carbon nanotube dispersion solution having high conductivity and high dispersibility can be prepared. By using the non-oxidized carbon nanotube dispersion solution as a carbon nanotube conductive material during the manufacturing of electrodes for secondary batteries that require high capacity, long life, and high stability electrochemical properties, battery performance can be improved. This illustrates that the present disclosure ultimately has the effect of enabling the mass production of high-performance secondary battery conductive materials through a simple process without acid treatment.

### BRIEF DESCRIPTION OF THE DRAWINGS

FIG. 1 shows a flow chart of a method of preparing a non-oxidized carbon nanotube dispersion solution according to the present disclosure;

FIG. 2(a) shows a process diagram of preparing a carbon nanotube dispersion solution through conventional mechanical pulverization, and FIG. 2(b) shows a process diagram of preparing a carbon nanotube dispersion solution through mechanical impregnation of the present disclosure;

FIG. 3(a) shows a photograph of single-walled carbon nanotube powder, FIG. 3(b) shows a photograph of a single-walled carbon nanotube dispersion solution prepared through a mechanical impregnation process according to Example 1 using the single-walled carbon nanotube powder of FIG. 3(a), and FIG. 3(c) shows a photograph of a single-walled carbon nanotube dispersion solution in which the single-walled carbon nanotube powder of FIG. 3(a) is dispersed in water without a mechanical impregnation process;

FIG. 4(a) shows a photograph of multi-walled carbon nanotube powder, FIG. 4(b) shows a photograph of a multi-walled carbon nanotube dispersion solution prepared through a mechanical impregnation process according to Example 2 using the multi-walled carbon nanotube powder of FIG. 4(a), and FIG. 4(c) shows a photograph of a multi-walled carbon nanotube dispersion solution in which the multi-walled carbon nanotube powder of FIG. 4(a) is dispersed in water without a mechanical impregnation process;

FIG. 5(a) shows an SEM image of pristine single-walled carbon nanotubes, and FIG. 5(b) shows an SEM image of single-walled carbon nanotubes prepared through a mechanical impregnation process according to Example 1;

FIG. 6(a) shows an SEM image of pristine multi-walled carbon nanotubes, and FIG. 6(b) shows an SEM image of multi-walled carbon nanotubes prepared through a mechanical impregnation process according to Example 2;

FIG. 7(a) shows a photograph of bucky paper and a table showing the electrical conductivity results of bucky paper according to Example 1, and FIG. 7(b) shows a photograph of bucky paper and a table showing the electrical conductivity results of bucky paper according to Example 2;

FIG. 8(a) shows a charge/discharge graph of a half-cell manufactured with a conductive material made with multi-walled carbon nanotubes prepared through mechanical impregnation according to Example 2, and FIG. 8(b) shows a charge/discharge graph of a half-cell manufactured with a conductive material made with carbon black; and

FIG. 9(a) shows a graph comparing the initial voltage changes during cycle discharge of half-cells manufactured with a conductive material made with multi-walled carbon nanotubes prepared through mechanical impregnation according to Example 2 and a conductive material made with carbon black, respectively, FIG. 9(b) shows an enlarged graph of area i of FIG. 9(a), and FIG. 9(c) shows a graph and a table comparing electrical resistance.

### DETAILED DESCRIPTION OF THE INVENTION

The present disclosure may have various modifications and various forms, and embodiments thereof will be described in detail in the text. However, this is not intended to limit the present disclosure to a specific disclosure form but should be understood to include all modifications, equivalents, or substitutes included in the spirit and technical scope of the present disclosure.

Throughout the specification, whenever a part is said to “include” a component, this does not mean that it excludes other components, but rather that it may include other components, unless otherwise stated.

Unless otherwise defined, all terms used herein, including technical or scientific terms, have the same meaning as commonly understood by one of ordinary skill in the art to which this present disclosure belongs. Terms defined in commonly used dictionaries should be interpreted to have a meaning consistent with their meaning in the context of the relevant technology. Unless expressly defined herein, the terms shall not be construed in an ideal or overly formal sense.

The terms used herein are to describe particular embodiments only and are not intended to limit the present disclosure. Singular expressions include plural expressions unless the context clearly indicates otherwise.

However, impregnation described in this specification means a phenomenon in which a binder penetrates between carbon nanotubes in a bundle shape.

In addition, mechanical impregnation described in this specification means a phenomenon in which a binder penetrates between carbon nanotubes in a bundle shape by applying a physical mechanical shear force rather than a chemical reaction. This means that the mechanical impregnation in this specification includes a kneading method of carbon nanotubes and a shear mixing method in which a binder penetrates between carbon nanotubes through the shear force.

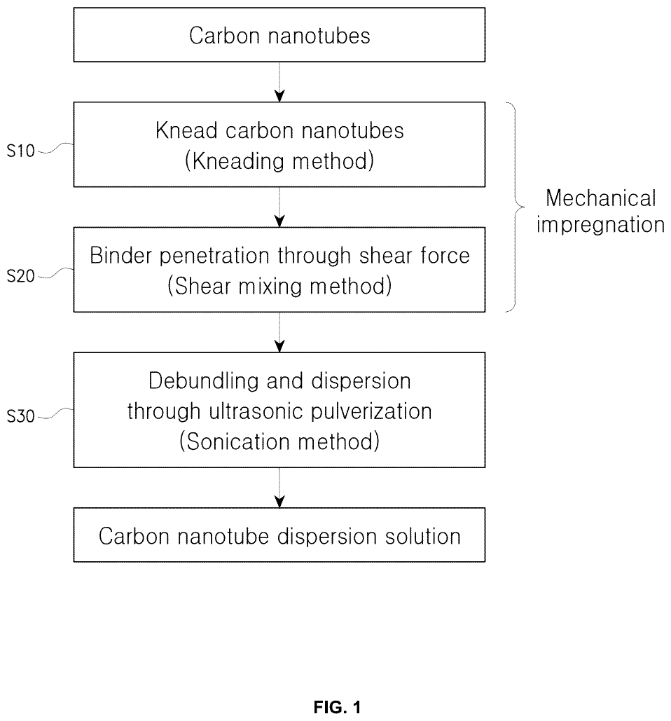

The present disclosure relates to a method of preparing a non-oxidized carbon nanotube dispersion solution using mechanical impregnation. In regard to this, FIG. 1 shows a flow chart of a method of preparing a non-oxidized carbon nanotube dispersion solution according to the present disclosure. As shown in FIG. 1, the non-oxidized carbon nanotube dispersion solution is prepared using mechanical impregnation by a method including: S10 preparing a carbon nanotube dough by kneading carbon nanotubes in a bundle shape and alcohol so that the surface of each of the carbon nanotubes in the bundle shape is wet; S20 preparing a carbon nanotube-binder mixture by mixing the carbon nanotube dough with a binder and applying a shear force to the mixture; and S30 preparing a carbon nanotube dispersion solution in which each of the carbon nanotubes is debundled and dispersed by sonicating the carbon nanotube-binder mixture. Herein, after alcohol penetrates between each of the carbon nanotubes during kneading, the binder penetrates between each of the carbon nanotubes during the preparation of the carbon nanotube-binder mixture, thereby causing mechanical impregnation.

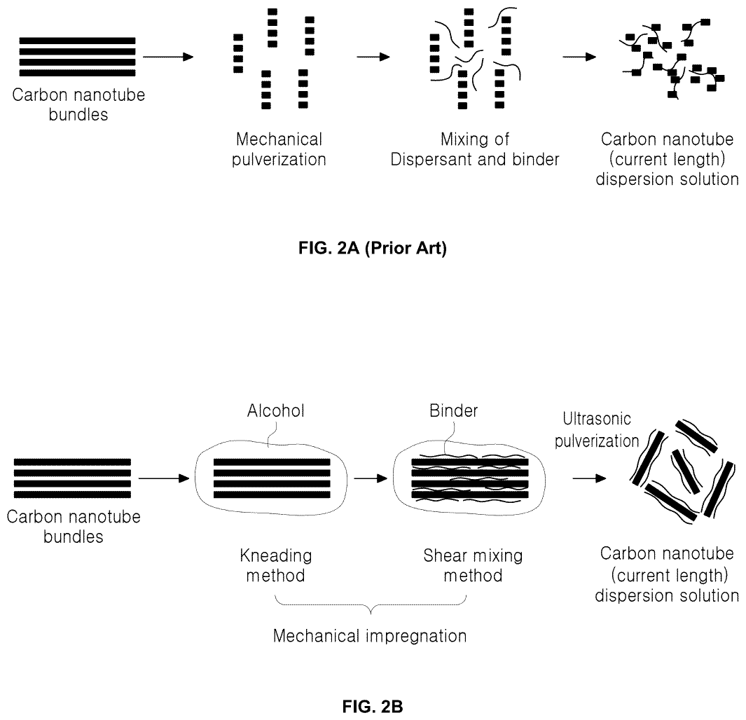

Specifically, FIG. 2(a) shows a process diagram of preparing a carbon nanotube dispersion solution through conventional mechanical pulverization, and FIG. 2(b) shows a process diagram of preparing a carbon nanotube dispersion solution through mechanical impregnation of the present disclosure.

To disperse carbon nanotubes without conventional acid treatment, as shown in FIG. 2(a), carbon nanotubes were first mechanically pulverized using expensive equipment, and then a dispersant (for example, surfactant) and a binder were mixed to prepare a carbon nanotube dispersion solution. In this case, due to the mechanical pulverization, the carbon nanotubes have a shortened length. When carbon nanotubes have a shortened length, the conductivity of the carbon nanotubes improves compared to carbon black, but it becomes difficult to fully utilize the conductivity properties of carbon nanotubes themselves. Accordingly, there is a need to form the carbon nanotubes longer than that in the case of FIG. 2(a). A method of debundling and dispersing carbon nanotubes without mechanically pulverizing the carbon nanotubes is shown in FIG. 2(b).

Referring to FIG. 2(b), when carbon nanotubes in a bundle shape are mechanically impregnated by a kneading method and a shear mixing method and then are subject to ultrasonic pulverization, a carbon nanotube dispersion solution of carbon nanotubes having a relatively longer length than those in the case of FIG. 2(a) may be prepared.

According to the preparation method described above, first, carbon nanotubes in a bundle shape and alcohol are kneaded to prepare a carbon nanotube dough in which the surface of each of the carbon nanotubes in the bundle shape is wet (S10).

The carbon nanotube used may include one or more selected from the group consisting of a single-walled carbon nanotube (SWCNT), a double-walled carbon nanotube (DWCNT), a thin multi-walled carbon nanotube (thin MWCNT), and a multi-walled carbon nanotube (MWCNT). Pretreatment including kneading is performed to wet the surface of the carbon nanotubes to facilitate debundling and dispersion of the carbon nanotubes. Since carbon nanotubes in a powder form themselves have a hydrophobic surface, the carbon nanotubes make it difficult to disperse in water. Thus, kneading is performed by using a medium of alcohol, which eliminates the hydrophobicity of the carbon nanotubes and imparts hydrophilicity to the carbon nanotubes.

It is important not only to add carbon nanotubes to the alcohol but also to knead the mixture to ensure that the carbon nanotubes are in a wet state, exhibiting a swelling phenomenon. Since a shear force is applied to the carbon nanotubes during kneading, it may be said that mechanical force is provided.

Because the carbon nanotubes are hydrophobic, the alcohol is used to wet the carbon nanotubes. When the surface of the carbon nanotubes is not made wet, the debundling and dispersion of the carbon nanotubes will not occur properly, and the carbon nanotubes aggregate in aqueous or organic phases.

The alcohol used for the carbon nanotube dough may include one or more selected from the group consisting of primary alcohol, secondary alcohol, and tertiary alcohol. The primary alcohol may include one or more selected from the group consisting of methanol, ethanol, n-propanol, n-butanol, n-amyl alcohol, n-hexyl alcohol, n-heptanol, and n-octanol. The secondary alcohol may include one or more selected from the group consisting of isopropanol, isobutanol, isoamyl alcohol, and 3-pentanol. The tertiary alcohol may include one or more selected from the group consisting of t-butanol, t-amyl alcohol, 2,3-dimethyl-2-butanol, 2-(trifluoromethyl)-2-propanol, 3-methyl-3-pentanol, 3-ethyl-3-pentanol, 2-methyl-2-pentanol, 2,3-dimethyl-3-pentanol, 2,4-dimethyl-2-pentanol, 2-methyl-2-hexanol, 2-cyclopropyl-2-propanol, 2-cyclopropyl-2-butanol, 2-cyclopropyl-3-methyl-2-butanol, 1-methylcyclopentanol, 1-ethylcyclopentanol, 1-propylcyclopentanol, 1-methylcyclohexanol, 1-ethylcyclohexanol, and 1-methylcycloheptanol. Herein, the types of alcohol are not limited to the types of the alcohol mentioned above. Any alcohol, which may wet the hydrophobic surface of carbon nanotubes through kneading thereby imparting a hydrophilic surface to the carbon nanotubes, may be used in a variety of ways.

The carbon nanotubes and alcohol as described above may be kneaded at a weight ratio of 1:5 to 20. When the alcohol is contained at a weight ratio of less than 5 per 1 weight of carbon nanotubes, the kneading efficiency is reduced, so the alcohol application may not be regarded as the pretreatment to facilitate the debundling and dispersion of carbon nanotubes. Meanwhile, when the alcohol is contained at a weight ratio of more than 20, the amount of the alcohol increases excessively, thereby inefficient aspects of the process, such as solvent evaporation, may become apparent later.

Next, the carbon nanotube dough is mixed with a binder, and a shear force is applied to prepare a carbon nanotube-binder mixture (S20).

After mixing the carbon nanotube dough with a binder, a shear force is applied for the binder to penetrate between the carbon nanotubes. A binder is a material that physically stabilizes the electrode of a secondary battery. Based on the property, a binder is used to maintain conditions of positive and negative electrode active materials in secondary batteries and also helps to maintain a durable connection between the electrode and the conductive material. Therefore, a binder may function as a kind of adhesive that adheres active materials and conductive materials to current collectors.

When the binder does not act as a binder used in secondary batteries, the binder may cause a side reaction in the secondary battery conductive materials. For this reason, the binder preferably includes one or more selected from the group consisting of carboxymethyl cellulose (CMC), polyacrylic acid (PAA), polyvinylidenefluoride (PVDF), polyvinyl alcohol (PVA), polymethyl methacrylate (PMMA), polyvinyl alcohol-polyacrylic acid copolymers (PVA-PAA copolymers), lithium polyacrylate (LiPAA), polyimide (PI), polyisobutylene (PIB), and styrene-butadiene rubber (SBR).

Lastly, the carbon nanotube-binder mixture is sonicated to prepare a carbon nanotube dispersion solution in which each of the carbon nanotubes is debundled and dispersed (S30).

By sonicating the carbon nanotube-binder mixture in a solution state, a carbon nanotube dispersion solution in which each of the carbon nanotubes is debundled and dispersed may be prepared.

When ultrasonic pulverization is performed, the dispersed carbon nanotubes may have a length in the range of 1 to 50 μm. Since it is difficult to fully demonstrate the conductivity properties of the carbon nanotubes themselves when the length of the carbon nanotube is short, the carbon nanotubes preferably have a length in a range of at least 1 μm. When the length of the carbon nanotubes is above 50 μm, no better electrical conductivity effect is observed than carbon nanotubes with a shorter length. Accordingly, it is sufficient when the carbon nanotubes have a length of up to 50 μm. In this way, when the non-oxidized carbon nanotubes have a length in the range of 1 to 50 μm, the electrical conductivity properties may be efficiently exhibited.

As described above, by a mechanical impregnation method including a kneading method of carbon nanotubes, and a shear mixing method in which a binder penetrates between carbon nanotube bundles by applying a shear force, carbon nanotubes may be debundled. In addition, it enables to induce uniform dispersion of carbon nanotubes in organic as well as aqueous solvents.

In addition, the carbon nanotubes are debundled and dispersed in a non-oxidizing manner through mechanical impregnation without acid treatment. Therefore, the debundled carbon nanotubes may have a length of up to 50 μm. This ultimately has the effect of minimizing defects and improving electrical conductivity of carbon nanotubes, allowing the preparation of a non-oxidized carbon nanotube dispersion solution that may be used as an intermediate material for a negative or positive electrode conductive material for the secondary battery.

Hereinafter, examples of the present disclosure will be described in more detail. However, the following examples are provided only to help understand the present disclosure, and the scope of the present disclosure is not limited thereby.

### Example 1

### 1-1. Preparation of Carbon Nanotube Dough (Kneading Method)

At room temperature, 2 g of single-walled carbon nanotube powder was weighed into a reagent dish, and about 25 g of ethanol was slowly added using a dropper to gradually wet the surface of the carbon nanotubes in a powder form. At this point, the appropriate amount of ethanol added is determined depending on the number of layers of carbon nanotubes. In Example 1-1, 25 g of ethanol was added.

Afterward, a mixture of carbon nanotubes and ethanol was kneaded for 5 minutes using a spatula to prepare a dough of the carbon nanotube powder soaked with amphiphilic ethanol. Thereby, uniform mixing with a hydrophilic solvent was attempted later.

### 1-2. Preparation of Carbon Nanotube-Binder Mixture-Binder Impregnation Through Shear Force (Shear Mixing Method)

Carboxymethyl cellulose (CMC) was used as a binder to penetrate between carbon nanotubes. Carboxymethyl cellulose was generally used as an aqueous binder for natural graphite series negative electrodes, might improve the binding force of the electrode by increasing the viscosity of electrode slurry, and was environmentally friendly because water was used as a solvent.

First, 800 mL of a 0.25 g/L aqueous solution of carboxymethyl cellulose was prepared, and then the dough of the carbon nanotube powder prepared in Example 1-1 was added. By doing so, a mixed solution (800 mL) made of carbon nanotubes/ethanol, carboxymethyl cellulose, and water with a total concentration of 0.5 g/L (0.25 g/L of carbon nanotubes, 0.25 g/L of carboxymethyl cellulose) was prepared. Afterward, the mixed solution was dispersed at 3,600 rpm for 1 hour using a High Shear Mixer device. A strong shear force was applied by a high shear mixer. Thereby a carbon nanotube-binder mixture in a solution state was prepared in which the binder of carboxymethyl cellulose penetrated between carbon nanotubes in a bundle shape.

### 1-3. Preparation of Non-Oxidized Carbon Nanotube Dispersion Solution—Debundling and Dispersion Through Ultrasonication (Sonication Method)

For efficient ultrasonic pulverization, the 0.5 g/L solution of carbon nanotube-binder mixture prepared in Example 1-2 was diluted to a concentration of 0.2 g/L by adding distilled water, and used. When one-dimensional carbon nanotubes with a high aspect ratio were ultrasonically treated at high concentrations, the cavitation phenomenon might be inhibited, which might cause interference with ultrasonic energy transmission. Therefore, the 0.5 g/L non-oxidized carbon nanotube mixture solution prepared in Example 1-2 was diluted to a concentration of 0.2 g/L by adding distilled water and used. By debundling the carbon nanotubes using a sonicator in a horn form for three separate sessions of 5 minutes each, a non-oxidized carbon nanotube dispersion solution was prepared.

### Example 2

In Example 2, a non-oxidized carbon nanotube dispersion solution was prepared through the same process as Example 1, but about 20 g of ethanol was added to 2 g of multi-walled carbon nanotube powder instead of single-walled carbon nanotube powder to prepare a non-oxidized carbon nanotube dispersion solution.

### <Comparative Example 1> Preparation of Non-Oxidized Carbon Nanotube Dispersion Solution Using Commercial Technology (Mechanical Pulverization and Dispersant)

First, ball milling was performed to mechanically pulverize carbon nanotubes. 3 g of single-wall carbon nanotube powder and 100 g of zirconia balls were placed in a dedicated SUS chamber at room temperature. Then, the mixture was ball milled at 350 rpm for 30 minutes using a planetary ball mill and then cooled for 30 minutes. The process was considered as one cycle, and the cycle was repeated 12 times. In this way, ball milling was performed for a total of 360 minutes. After preparing 800 mL of 0.25 g/L aqueous solution of carboxymethyl cellulose, 2 g of carbon nanotube powder that had undergone a ball milling process was added. Thereby, a mixed solution (800 mL) made of carbon nanotubes, carboxymethyl cellulose, and water with a total concentration of 0.5 g/L (0.25 g/L of carbon nanotubes, 0.25 g/L of carboxymethyl cellulose) was prepared. As in Example 1-3, the 0.5 g/L mixed solution was diluted to a concentration of 0.2 g/L, and then the mixture was subjected to a sonication treatment using a sonicator in a horn form for three separate sessions of 5 minutes each. By using mechanical pulverization and a dispersant, a non-oxidized carbon nanotube dispersion solution was prepared.

### Comparative Example 2

In Comparative Example 2, a non-oxidized carbon nanotube dispersion solution was prepared through the same process as Comparative Example 1, but multi-walled carbon nanotubes were used instead of the single-walled carbon nanotubes to prepare a non-oxidized carbon nanotube dispersion solution.

### Experimental Example 1

In this experimental example, the debundling and dispersibility of a single-walled carbon nanotube dispersion solution prepared through a mechanical impregnation process according to Example 1 and a multi-walled carbon nanotube dispersion solution prepared through a mechanical impregnation process according to Example 2 were analyzed.

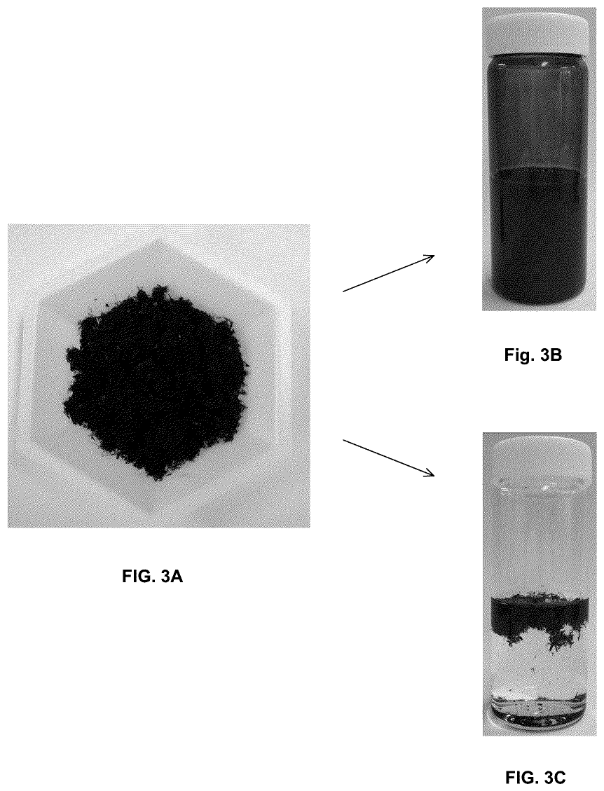

First, FIG. 3(a) shows a photograph of single-walled carbon nanotube powder in its raw material state. FIG. 3(b) shows a photograph of a single-walled carbon nanotube dispersion solution prepared by mechanically impregnating the single-walled carbon nanotube powder of FIG. 3(a) according to Example 1. Despite the difficulty in debundling of the single-walled carbon nanotubes compared to multi-walled carbon nanotubes, uniform dispersion of the single-walled carbon nanotubes was achieved as shown in FIG. 3(b). FIG. 3(c) shows a photograph of a single-walled carbon nanotube dispersion solution in which the single-walled carbon nanotube powder of FIG. 3(a) is simply dispersed in water without going through a mechanical impregnation process. From this, it was confirmed that the single-walled carbon nanotube powder of FIG. 3(a) was dispersed in an aqueous solution without any treatment, but was not dispersed.

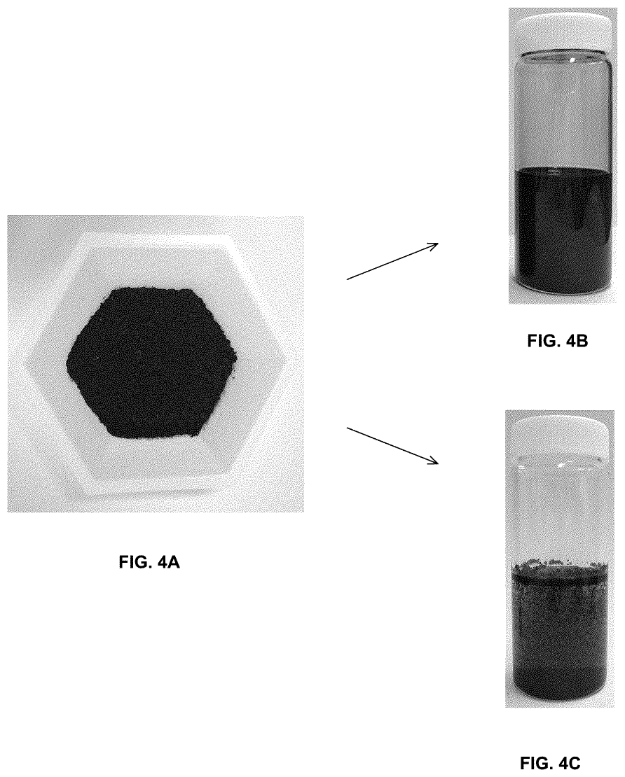

FIG. 4(a) shows a photograph of multi-walled carbon nanotube powder in its raw material state. FIG. 4(b) shows a photograph of a multi-walled carbon nanotube dispersion solution prepared by mechanically impregnating the multi-walled carbon nanotube powder of FIG. 4(a) according to Example 2. From this, it was confirmed that the multi-walled carbon nanotubes were uniformly dispersed through the mechanical impregnation process.

FIG. 4(c) shows a photograph of a multi-walled carbon nanotube dispersion solution in which the multi-walled carbon nanotube powder of FIG. 4(a) is dispersed in water without going through a mechanical impregnation process. Referring to FIG. 4(c), it was confirmed that when the multi-walled carbon nanotube powder was simply dispersed in water, dispersion did not occur, and the multi-walled carbon nanotube powder was scattered.

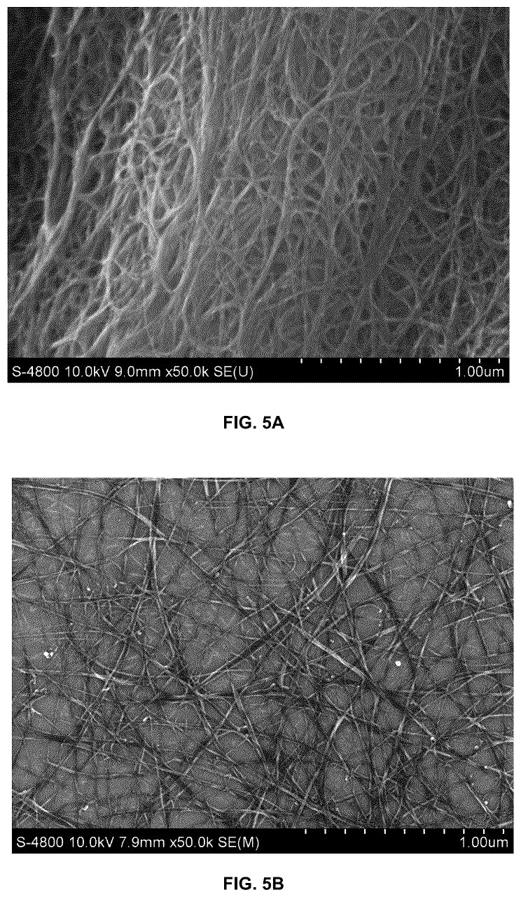

FIG. 5(a) shows an SEM image of pristine single-walled carbon nanotubes. FIG. 5(a) shows an SEM image of a sample spin-coated on a SiO2 wafer. Herein, before the spin-coating, distilled water was added to dilute the pristine single-walled carbon nanotubes to a concentration of 0.01 g/L, and then the pristine single-walled carbon nanotubes were subjected to mechanical impregnation treatment. The morphology of the pristine single-walled carbon nanotubes in a bundle state was confirmed.

FIG. 5(b) shows an SEM image of single-walled carbon nanotubes prepared through a mechanical impregnation process according to Example 1. FIG. 5(b) shows an SEM photograph of a sample spin-coated on a SiO2 wafer. Herein, before the spin-coating, distilled water was added to dilute the non-oxidized single-walled carbon nanotube dispersion solution of Example 1 to a concentration of 0.01 g/L. Through the mechanical impregnation process, debundling was performed, and as a result, the single-walled carbon nanotubes showing high dispersity were confirmed.

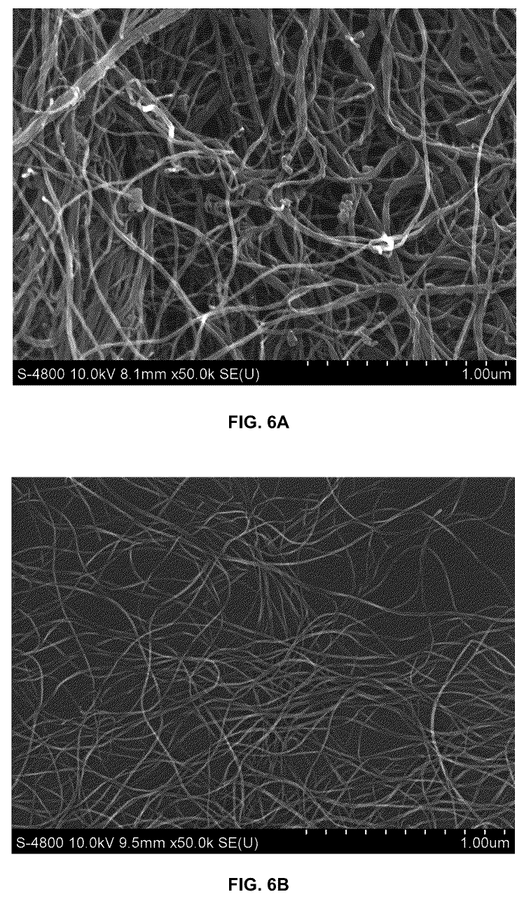

FIG. 6(A) shows an SEM image of pristine multi-walled carbon nanotubes. FIG. 6(a) shows a sample spin-coated on a SiO2 wafer. Herein, before the spin-coating, distilled water was added to dilute the pristine multi-walled carbon nanotubes to a concentration of 0.01 g/L, and then the pristine multi-walled carbon nanotubes were subjected to mechanical impregnation treatment. The morphology of the pristine multi-walled carbon nanotubes in a bundle state was confirmed.

FIG. 6(b) shows an SEM image of multi-walled carbon nanotubes prepared through a mechanical impregnation process according to Example 2. FIG. 6(b) shows a sample spin-coated on a SiO2 wafer. Herein, before the spin-coating, distilled water was added to dilute the non-oxidized multi-walled carbon nanotube dispersion solution of Example 2 to a concentration of 0.01 g/L. Through the mechanical impregnation process, debundling was performed, and as a result, the multi-walled carbon nanotubes highly dispersed were confirmed.

### Experimental Example 2

In this experimental example, the electrical conductivity of a single-walled carbon nanotube dispersion solution prepared through a mechanical impregnation process according to Example 1 and a multi-walled carbon nanotube dispersion solution prepared through a mechanical impregnation process according to Example 2 was analyzed.

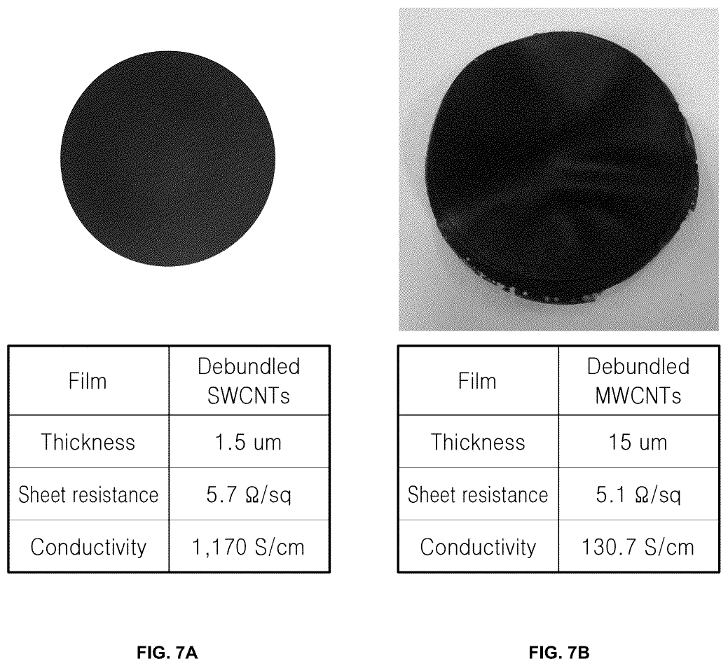

FIG. 7(a) shows a photograph of bucky paper and a table showing the electrical conductivity results of bucky paper according to Example 1. That is, in FIG. 7(A), the table shows a photograph of bucky paper obtained by vacuum filtering 1 g of the 0.2 g/L non-oxidized single-walled carbon nanotube dispersion solution obtained in Example 1 through an anodic aluminum oxide membrane (AAO membrane) and a table showing the electrical conductivity results obtained through 4 probe measurement method. In the case of electrical conductivity, because the debundling and dispersion of the single-walled carbon nanotubes were well achieved, the electrical conductivity was measured at 1,170 S/cm when the thickness of the bucky paper was 1.5 μm. The electrical conductivity value confirmed that the debundling and dispersion of the single-walled carbon nanotubes were successfully achieved.

FIG. 7(b) shows a photograph of bucky paper obtained by vacuum filtering 20 g of the 0.2 g/L non-oxidized multi-walled carbon nanotube dispersion solution obtained in Example 2 through an anodic aluminum oxide membrane (AAO membrane) and a table showing the electrical conductivity results obtained through 4 probe measurement method. In the case of multi-walled carbon nanotubes, it was confirmed that the electrical conductivity was measured at 130.7 S/cm, which far exceeded the previously reported electrical conductivity of 33 S/cm.

### Experimental Example 3

In this experimental example, a half-cell secondary battery evaluation was conducted with a non-oxidized carbon nanotube conductive material prepared through mechanical impregnation and a conventional carbon black conductive material on the market.

To use the non-oxidized carbon nanotubes prepared in Example 2 as a conductive material, a slurry electrode was prepared with silicon active material, non-oxidized carbon nanotube, and binder at a weight ratio of 80:2:18. A copper current collector was coated with the slurry using an electrode coater, and then placed in an oven at a temperature of 100° C. and vacuum dried for 24 hours. In the slurry coating, the copper current collector was prepared to achieve a loading capacity per area in a range of up to 4.1 mAh/cm2. The coated copper current collector was rolled and punched into a circular electrode with a diameter of 14 mm. The resulting product was used as a negative electrode to manufacture a half cell. A coin cell of CR2032 standard was manufactured by using the negative electrode and electrolyte (1.0 M LiPF6 in EC/EMC( 3/7 vol. %)+VC(1.5)+PS(0.5) wt. %), a separator (PE), and a lithium counter electrode. The manufactured coin cell was stabilized at a temperature of 30° C. for 40 hours and then was subjected to one formation cycle (Charge 0.1 C CC, 0.005 C CV, Cut-off (0.005 V)_Rest 30 min/Discharge 0.1 C, Cut-off (1.5 V)_Rest 30 min) at room temperature.

Meanwhile, to use conventional carbon black as a conductive material, a slurry electrode was prepared with silicone active material, carbon black, and binder at a weight ratio of 80:10:10. A copper current collector was coated with the slurry using an electrode coater, then placed in an oven at a temperature of 100° C. and vacuum dried for 24 hours. In the slurry coating, the copper current collector was prepared to achieve a loading capacity per area in a range of up to 4.1 mAh/cm2. The coated copper current collector was rolled and punched into a circular electrode with a diameter of 14 mm. The resulting product was used as a negative electrode to manufacture a half cell. A coin cell of CR2032 standard was manufactured by using the negative electrode and electrolyte (1.0 M LiPF6 in EC/EMC( 3/7 vol. %)+VC(1.5)+PS(0.5) wt. %), a separator (PE), and a lithium counter electrode. The manufactured coin cell was stabilized at a temperature of 30° C. for 40 hours and then was subjected to one formation cycle (Charge 0.1 C CC, 0.005 C CV, Cut-off (0.005 V)_Rest 30 min/Discharge 0.1 C, Cut-off (1.5 V)_Rest 30 min) at room temperature.

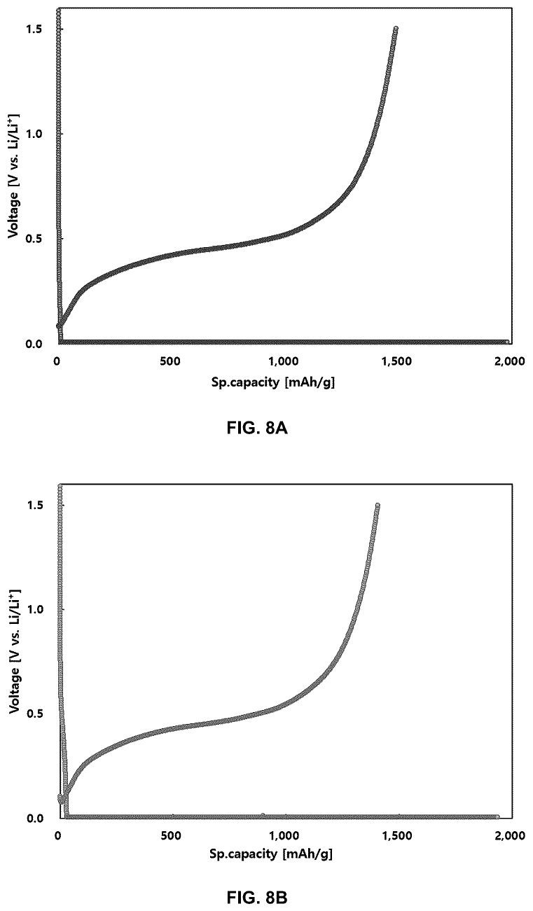

FIG. 8(a) shows a charge/discharge graph of a half-cell manufactured with a conductive material made with multi-walled carbon nanotubes prepared through mechanical impregnation according to Example 2, and FIG. 8(b) shows a charge/discharge graph of a half-cell manufactured with a conductive material made with carbon black.

When looking at the charge/discharge graphs to compare the results of one formation cycle of two types of half cells manufactured with non-oxidized carbon nanotubes and conventional carbon black as a conductive material, respectively, the discharge capacity of the conventional carbon black conductive material was 1,408 mAh/g, and the initial efficiency (ICE) was 72%. On the other hand, the discharge capacity of the non-oxidized carbon nanotube conductive material of the present disclosure was 1,490 mAh/g, and the initial efficiency (ICE) was 75%. From this, it was confirmed that the capacity and initial efficiency increased when non-oxidized carbon nanotubes prepared through mechanical impregnation according to the present disclosure were used as a conductive material.

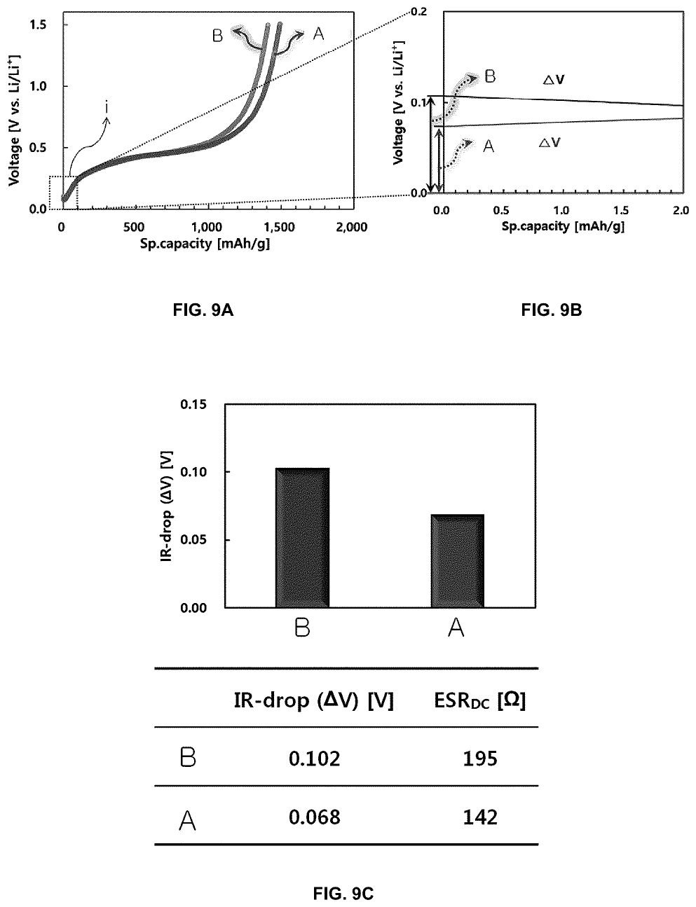

FIG. 9(a) shows a graph comparing the initial voltage changes during cycle discharge of half-cells manufactured with a conductive material made with multi-walled carbon nanotubes prepared through mechanical impregnation according to Example 2 and a conductive material made with carbon black, respectively, FIG. 9(b) shows an enlarged graph of area i of FIG. 9(A), and FIG. 9(c) shows a graph and a table comparing electrical resistance. FIG. 9(a) shows the case of the non-oxidized carbon nanotube conductive material of the present disclosure, and FIG. 9(b) shows the case of the conventional carbon black conductive material.

Herein, the ESR DC (IR-drop) measurement was calculated by dividing the voltage value (ΔV) by the current value, the voltage value (ΔV) being obtained in the voltage drop section where discharge begins at a current of 0.1 C. The calculation formula is as follows.

$$ESR DC ( IR - drop ) = Δ V / I \qquad [ Formula 1 ]$$

After charging, when discharging occurs, an IR-drop happens on a discharge curve. This means a cell does not charge to 0 V and discharge again from 0 V. Instead of discharging at 0 V, a certain voltage appears. When looking at FIG. 9(b), which enlarges this resistance part, it was confirmed that ΔV in the case of the carbon black conductive material floated more than that in the case of non-oxidized carbon nanotube conductive material, so the resistance was higher.

This illustrated that when the non-oxidized carbon nanotubes of the present disclosure were applied as a conductive material, the resistance value was lower than when carbon black was applied as a conductive material, and due to this difference in resistance, in the case of the non-oxidized carbon nanotubes of the present disclosure, the initial efficiency increased to 75%, and the discharge capacity also increased to 1,490 mAh/g.

As described above, from the graphs and tables comparing the initial voltage change and electrical resistance during the discharge of two types of half-cells after one formation cycle, the two types of half-cells being manufactured with the non-oxidized carbon nanotube conductive material of the present disclosure and the conventional carbon black conductive material, respectively, it was confirmed that the initial IR-drop phenomenon was more avoided when with non-oxidized carbon nanotubes prepared through mechanical impregnation according to the present disclosure were used than when with carbon black. This illustrated that the electrical conductivity and ionic conductivity of the electrode were improved.

To summarize this, through the present disclosure, it is possible that carbon nanotube powder and alcohol are kneaded to uniformly mix carbon nanotubes having a hydrophobic surface with a hydrophilic solvent, next, the mixed product is mixed with a binder, and the binder penetrates between the carbon nanotubes through shear force to prepare a carbon nanotube-binder mixture in a solution state, and the carbon nanotube-binder mixture is debundled and solvent dispersed through ultrasonic waves to prepare a uniformly dispersed non-oxidized carbon nanotube dispersion solution. That is, by mechanical impregnation including the kneading method and the shear induced mixing method, and by the debundling and the sonication method using ultrasonic waves, the binder may effectively penetrate between the carbon nanotube bundles, resulting in the induction of uniform dispersion of the carbon nanotubes in a hydrophilic solvent. Ultimately, a non-oxidized carbon nanotube dispersion solution may be prepared without acid treatment, and this leads to the possibility of manufacturing intermediate materials for secondary battery conductive materials.

According to these properties, it is expected that a non-oxidized carbon nanotube dispersion solution with high conductivity and high dispersion is prepared without using an acid treatment process during the dispersion of the carbon nanotubes. Based on this, by using carbon nanotube conductive materials during the manufacturing of electrodes for secondary batteries that require high capacity, long life, and high stability electrochemical properties, battery performance may be improved. Ultimately, it enables the mass production of high-performance secondary battery conductive materials through a simple process without acid treatment.

The description is merely an illustrative explanation of the technical idea of the present disclosure, and those skilled in the art will be able to make various modifications and variations without departing from the essential characteristics of the present disclosure. Therefore, the examples disclosed in the present disclosure are not intended to limit the technical idea of the present disclosure but are for explanation. The scope of the technical idea of the present disclosure is not limited by these examples. The scope of protection of the present disclosure should be interpreted in accordance with the scope of the patent claims, and all technical ideas within the equivalent scope should be interpreted as being included in the scope of rights of the present disclosure.

1. A method of preparing a non-oxidized carbon nanotube dispersion solution using mechanical impregnation, the method comprising:
preparing a carbon nanotube dough by kneading carbon nanotubes in a bundle shape and alcohol so that the surface of each of the carbon nanotubes in the bundle shape is wet;
preparing a carbon nanotube-binder mixture by mixing the carbon nanotube dough with a binder and applying a shear force to the mixture; and
preparing a carbon nanotube dispersion solution in which each of the carbon nanotubes is debundled and dispersed by sonicating the carbon nanotube-binder mixture,
wherein, after the alcohol penetrates between each of the carbon nanotubes during kneading, the binder penetrates between each of the carbon nanotubes during the preparation of the carbon nanotube-binder mixture, thereby causing mechanical impregnation.

2. The method of claim 1, wherein the preparation of the carbon nanotube dough comprises kneading the carbon nanotubes and the alcohol at a weight ratio of 1:5 to 20.

3. The method of claim 1, wherein the carbon nanotube comprises one or more selected from the group consisting of a single-walled carbon nanotube (SWCNT), a double-walled carbon nanotube (DWCNT), a thin multi-walled carbon nanotube (thin MWCNT), and a multi-walled carbon nanotube (MWCNT).

4. The method of claim 1, wherein the binder comprises one or more selected from the group consisting of carboxymethyl cellulose (CMC), polyacrylic acid (PAA), polyvinylidenefluoride (PVDF), polyvinyl alcohol (PVA), polymethyl methacrylate (PMMA), polyvinyl alcohol-polyacrylic acid copolymers (PVA-PAA copolymers), lithium polyacrylate (LiPAA), polyimide (PI), polyisobutylene (PIB), and styrene-butadiene rubber (SBR).

5. The method of claim 1, wherein the debundled carbon nanotubes have a length in a range of 1 to 50 μm.

6. A non-oxidized carbon nanotube dispersion solution prepared by the method of claim 1.
